(19) United States
(12) Patent Application Publication
(10) Pub. No.: US 2009/0240498 A1
(43) Pub. Date: Sep. 24, 2009

(54) SIMILIARITY MEASURES FOR SHORT SEGMENTS OF TEXT

(75) Inventors: Wen-tau Yih, Redmond, WA (US); Alexei V. Bocharov, Redmond, WA (US); Christopher A. Meek, Kirkland, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/051,183

(22) Filed: Mar. 19, 2008

(51) Int. Cl. G10L 15/08

(52) U.S. Cl. 704/239; 704/E15.014

(57) ABSTRACT

Systems and methods to perform short text segment similarity measures. Illustratively, a short text segment similarity environment comprises a short text engine operative to process data representative of short segments of text and an instruction set comprising at least one instruction to instruct the short text engine to process data representative of short text segment inputs according to a selected short text similarity identification paradigm. Illustratively, two or more short text segments can be received as input by the short text engine and a request to identify similarities among the two or more short text segments. Responsive to the request and data input, the short text engine executes a selected similarity identification technique in accordance with the sort text similarity identification paradigm to process the received data and to identify similarities between the short text segment inputs.

### BACKGROUND

The problem of measuring the similarity between two short text segments has become increasingly important for many Web-related tasks. Examples of such tasks include query reformulation (similarity between two queries), search advertising (similarity between the user's query and advertiser's keywords), and product keyword recommendation (similarity between the given product name and suggested keyword).

Measuring the semantic similarity between two texts has been studied extensively. However, the problem of assessing the similarity between two short text segments poses new challenges. Text segments commonly found in these tasks range from a single word to a dozen words. Because of the short length, the text segments do not provide enough contexts for surface matching methods such as computing the cosine score of the two text segments to be effective. On the other hand, because many text segments in these tasks contain more than one or two words, traditional corpus-based word similarity measures can fail too.

These methods typically rely on the co-occurrences of the two compared text segments and, because of their lengths, they may not co-occur in any documents even when using the whole Web as the corpus. Because of the diversity of the text segments used in these Web applications, linguistic thesauruses commonly practiced do not cover a significant fraction of the input text segments. In order to overcome these difficulties, researchers have recently proposed several new methods for measuring similarity of short text segments.

Currently practiced methods can include surface matching, corpus-based methods (e.g., point-wise mutual information, latent semantic analysis, and normalized set overlap—testing whether the two text strings occur in the same document), query log methods, and web-relevance similarity measure. Regarding surface matching techniques, although different statistics for surface matching have their own strengths and weaknesses, their quality of measuring the similarity of very short text segments is usually unreliable. The described corpus-based method maintains shortcomings given that as the lengths of text segments increase, the chance that these two segments co-occur in some documents decreases substantially, which can affect the quality of the similarity measures. Query log methodologies are also lacking since the coverage for pairs of short text segments is limited because subsets of the words in both segments must appear in the same user session query logs.

From the foregoing it is appreciated that there exists a need for systems and methods to ameliorate the shortcomings of existing practices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The subject matter described herein allows for systems and methods to perform short text segment similarity measures. In an illustrative implementation, a short text segment similarity environment comprises a short text engine operative to process data representative of short segments of text and an instruction set comprising at least one instruction to instruct the short text engine to process data representative of short text segment inputs according to a selected short text similarity identification paradigm.

In an illustrative operation, two or more short text segments are received as input by the short text engine and a request to identify similarities among the two or more short text segments. Responsive to the request and data input, the short text engine executes a selected similarity identification technique in accordance with the sort text similarity identification paradigm to process the received data and to measure similarities between the short text segment inputs wherein the similarities are provided as similarity scores.

In an illustrative implementation, the selected short text similarity identification paradigm can comprise a web-relevance similarity measure. In an illustrative implementation and operation, short text segments are received by the short text engine and processed by a cooperating exemplary search engine according to the selected short text similarity identification paradigm to find documents containing words and/or categories of words in the input strings. Illustratively, for the documents processed, a keyword extractor and/or text categorizer component can be deployed to calculate a relevancy score of the words and/or categories of words for the processed documents. The documents can then be represented as document term vectors using the identified words (categories of words) and relevancy scores by the exemplary short text engine. Illustratively, the exemplary short text engine can operatively normalize the document term vector and calculate the averaged document term vector for the normalized document term vectors to generate a normalized averaged document term vector as output.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a block diagram of one example of an illustrative computing environment allowing for short text similarity identification in accordance with the herein described systems and methods.

FIG. 2 is a block diagram of exemplary components of an illustrative computing environment allowing for the identification of similarities in short text segments in accordance with the herein described systems and methods.

FIG. 3 is a block diagram of exemplary components of an illustrative computing environment allowing for the identification of similarities in short text segments in accordance with the herein described systems and methods.

FIG. 4 is a block diagram of other exemplary components of an illustrative collaborative computing environment allowing for the identification of similarities in short text segments in accordance with the herein described systems and methods.

FIG. 5 is a flow diagram of one example of an illustrative method to determine similarities among short text segments according to a selected short text identification paradigm.

FIG. 6 is a flow diagram of one example of an illustrative method performed to identify similarities among short text segments according to a selected short text identification paradigm.

FIG. 7 is a block diagram of an illustrative computing environment in accordance with the herein described systems and methods.

FIG. 8 is a block diagram of an illustrative networked computing environment in accordance with the herein described systems and methods.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Although the subject matter described herein may be described in the context of illustrative illustrations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

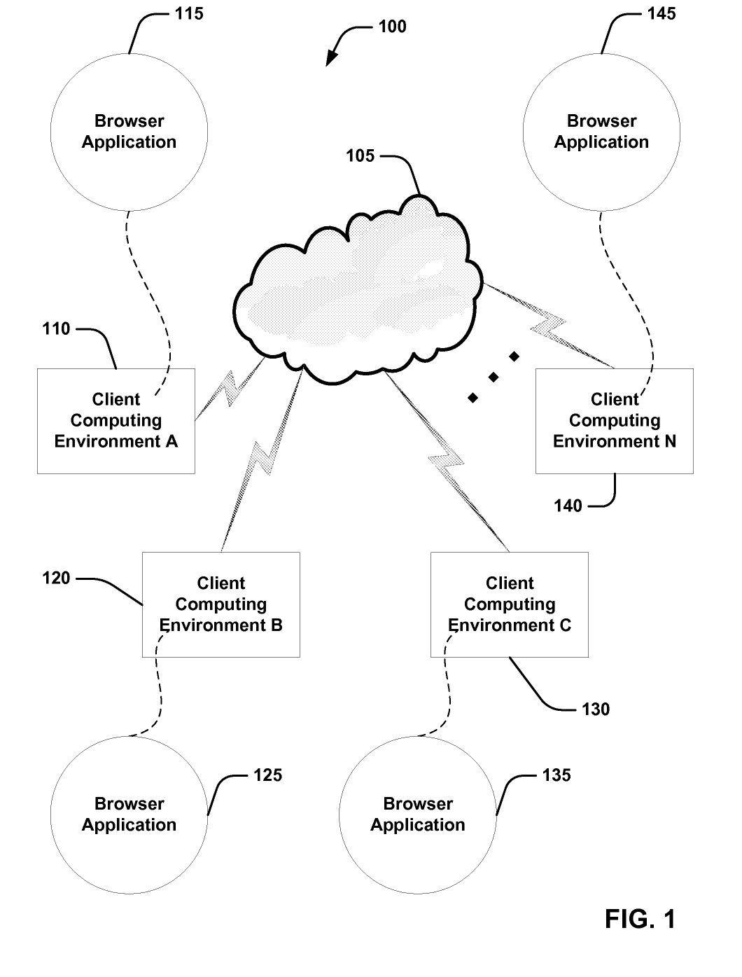

FIG. 1 describes an exemplary short text segment similarity environment 100. As is shown in FIG. 1, electronic short text segment similarity environment 100 comprises server network 105 (e.g., the Internet or the World Wide Web) operatively coupled to a plurality of client computing environments such as client computing environment A 100, client computing environment B 120, client computing environment C 130, up to and including client computing environment N 140. Further, as is shown in FIG. 1, the plurality of client computing environments can operate exemplary browser computing applications. As is shown, client computing environment A 110 operates browser application 115, client computing environment B 120 operates browser application 125, client computing environment C 130 operates browser application 135, up to and including client computing environment N 140 operating browser application 145.

In an illustrative operation, the plurality of client computing environments can communicate electronic data between each other and/or with server network 105. The communication of electronic data can be managed by the exemplary browser applications operating on the plurality of client computing environments. In the illustrative operation, the browser applications can operate to perform various operations and features including but not limited receiving data inputs and displaying for display and/or navigation retrieved electronic data.

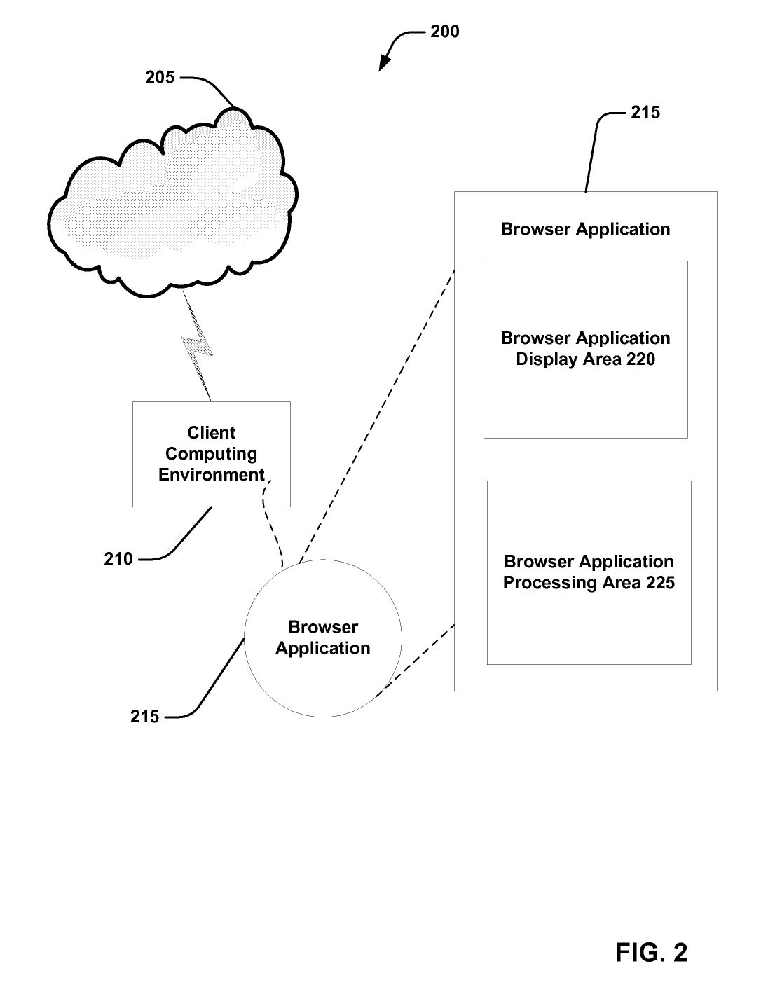

FIG. 2 describes an exemplary short text segment similarity environment 200. As is shown in FIG. 2, short text segment similarity environment 200 comprises sever network 205, client computing environment 210 operating browser application 215. Further, as is shown, browser application 215 comprises browser application display area 220 and browser application processing area 225. In an illustrative operation, a participating user (not shown) can interface with client computing environment 210 through browser application 215. In the illustrative operation, browser application 215 can receive one or more inputs to retrieve, search, communicate, and/or navigate electronic content. Illustratively, the input can be processed by browser application processing area 225 to allow for the display and/or navigation of electronic content in browser application display area 220.

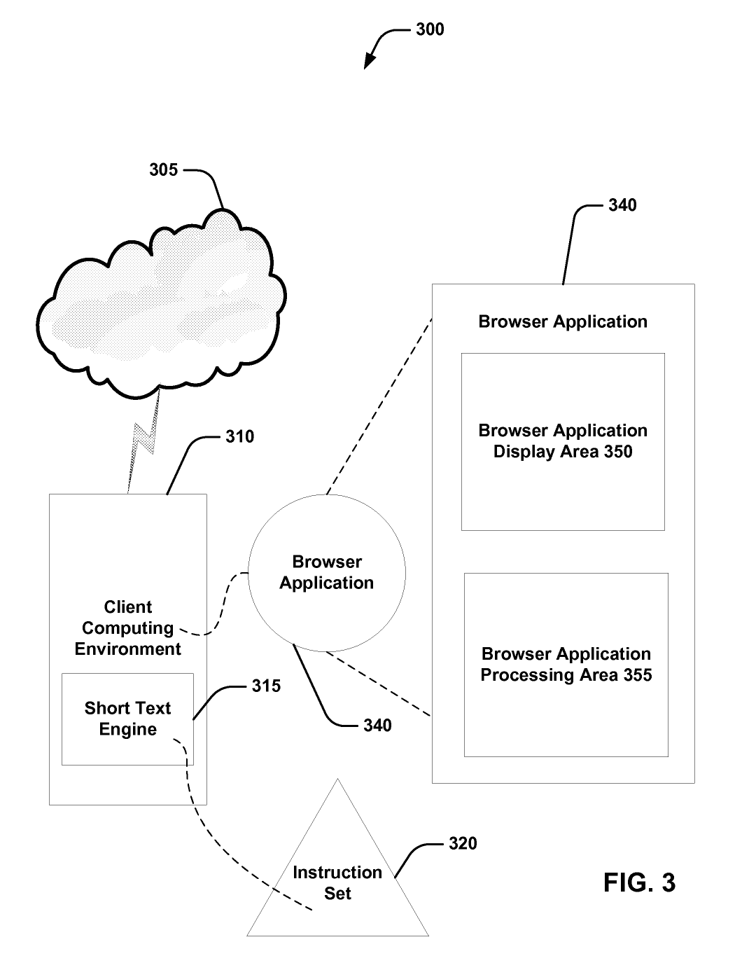

FIG. 3 schematically illustrates short text segment similarity environment 300. As is shown in FIG. 3, short text segment similarity environment 300 comprises server network 305, client computing environment 310 having short text engine 315 being directed by instruction set 320, and operating browser application 340. Further as is shown, browser application comprises browser application display area 350 and browser application processing area 355.

In an illustrative operation, short text engine 315 can operate on client computing environment 310 to receive data representative of short text segment string inputs (not shown) for processing according to instruction set 320. In the illustrative operation, instruction set 320 can comprise one or more instructions operative on short text engine 315 to process short text segment data according to a selected similarity identification paradigm. Illustratively, short text engine 315 can cooperate with browser application 340 to process short text engine data (not shown) on browser application processing area 355 for display, navigation, and/or modification on browser application display area 350.

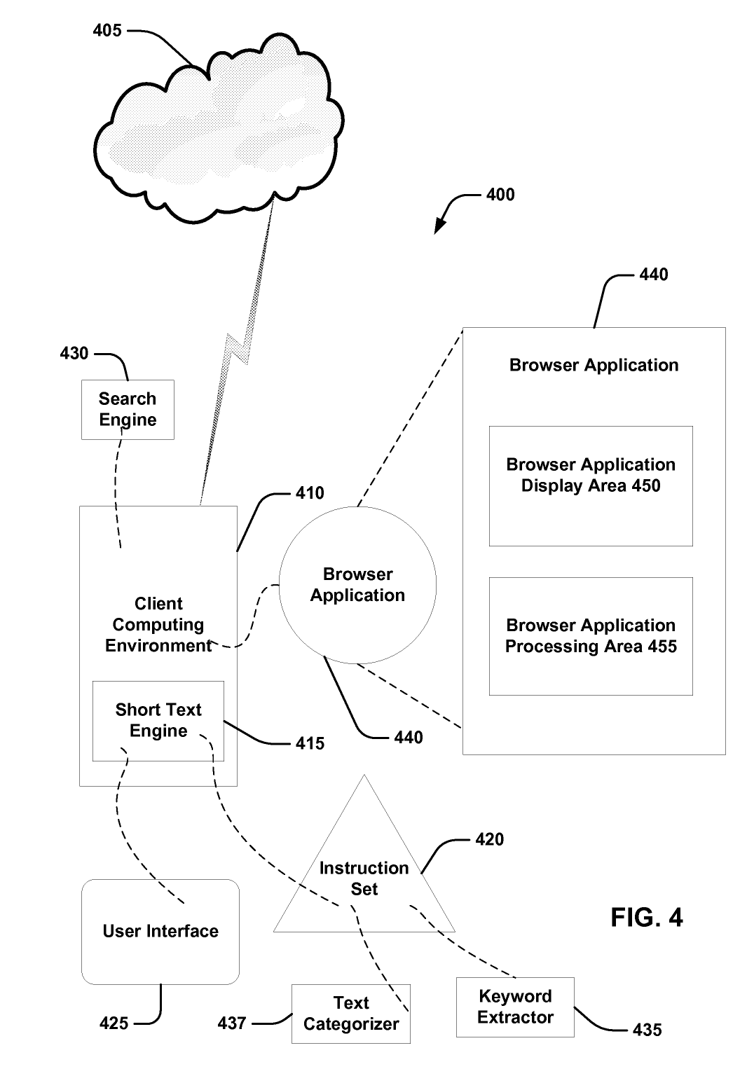

FIG. 4 schematically illustrates another short text segment environment 400. As is shown in FIG. 4, short text segment similarity environment 400 comprises server network 405 (e.g., the Internet connected to numerous other computing environments including search engine data stores), client computing environment 430 having short text engine 415 being directed by instruction set 420 having instructions to execute keyword extractor 435 and/or text categorizer 437, and operating browser application 440. Further, client computing environment 410 supports the execution of user interface 425 and search engine 430.

In an illustrative operation, short text engine 415 can operate on client computing environment 410 to receive data representative of short text segment string inputs (not shown) that can be received by short text engine 415 from user interface 425 for processing according to a selected similarity identification paradigm. Illustratively, short text engine 415 can cooperate with browser application 440 to process short text engine data (not shown) on browser application processing area 455 for display, navigation, and/or modification on browser application display area 450.

In an illustrative implementation, the search engine 415 can deploy a similarity identification paradigm comprising a web-relevancy measure. In the illustrative implementation, short text segment input strings received by short text engine 415 can be communicated for processing by search engine to operatively locate documents (e.g., search results) having words found in the received short text segment string inputs. In an illustrative operation, the located documents found by search engine 430 can be processed by keyword extractor 435 and/or text categorizer 437 to calculate a relevancy score for the document words and/or categories of words. Illustratively, the short text engine 415 can use the relevancy scores and the words of the received short text segment input strings to represent the one or more located documents as a vector. In the illustrative operation, the document vectors can then be normalized by the short text engine 415, and averaged to generate a normalized document term vector that can illustratively be provided as output to provide data representative of the similarities between the short text segment input strings.

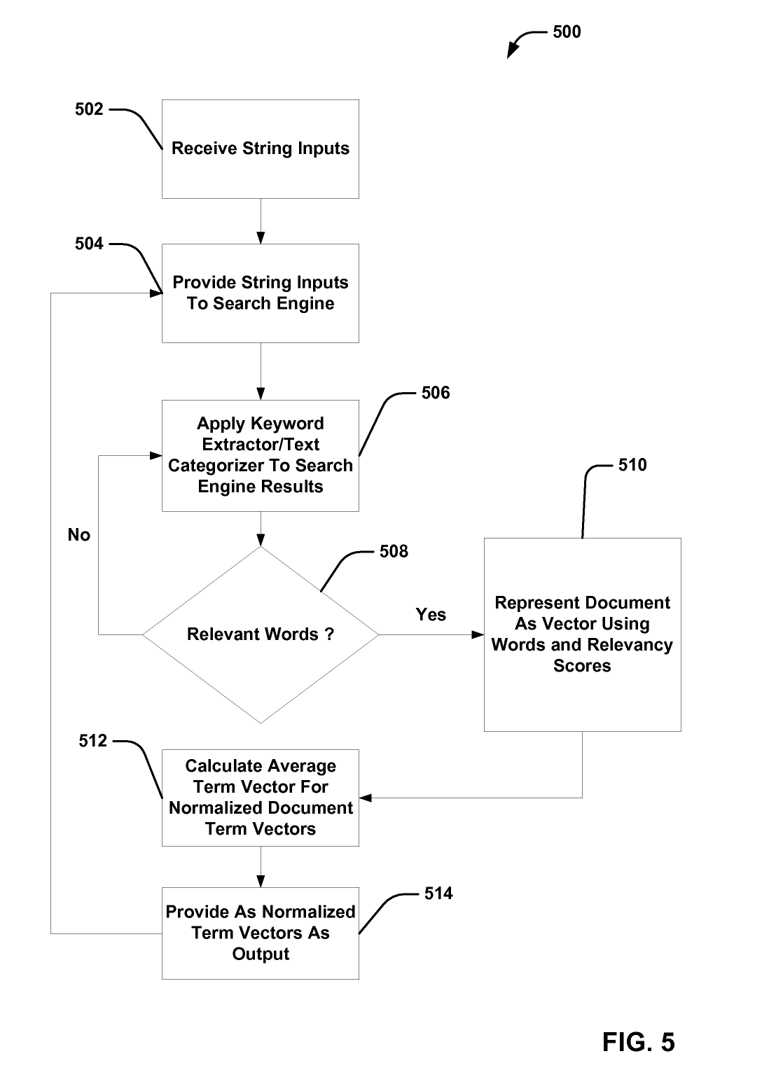

FIG. 5 is a block diagram of an illustrative method 500 for identifying similarities among short text segments. As is shown in FIG. 5, processing begins at block 502 where string inputs are received. Processing then proceeds to block 504 where the received string inputs are provided to a cooperating search engine. A keyword extractor and/or text categorizer can be applied to the search engine results at block 506. A check is then performed at block 508 to determine if there are relevant words (or categories of words) identified by the processing of block 506. If the check at block 508 determines that there relevant words have been identified, processing proceeds to block 510 where the document containing the words is represented as a vector using words and relevancy scores. Processing then proceeds to block 512 where the average term vector is calculated for normalized document term vectors. Processing then proceeds to block 514 where the normalized term vectors are provided as output. Processing then reverts to block 504 and continues from there.

However, if the check at block 518 determines that there are no relevant identified words, processing reverts to block 506 and proceeds from there.

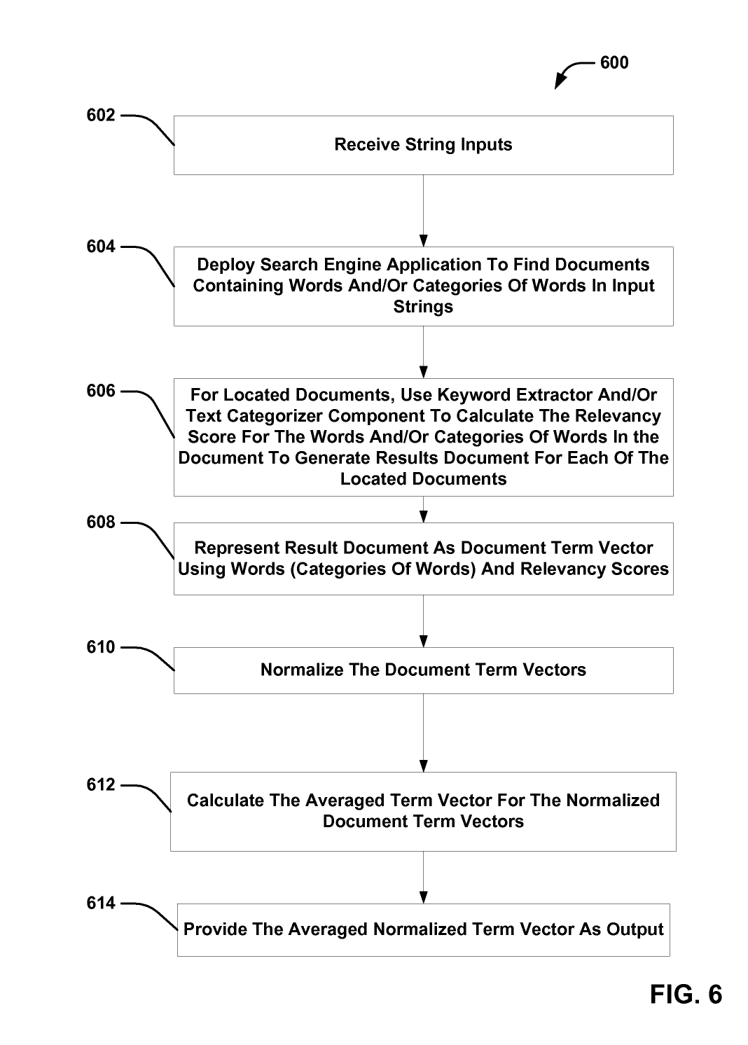

FIG. 6 is a flow diagram of one exemplary method 600 to identify similarities between short text segments. As is shown in FIG. 6, processing begins at block 602 where string inputs are received (e.g., short text segment input strings). Processing then proceeds to block 604 where a search engine application is deployed (e.g., by an exemplary short text engine) to find documents containing words and/or categories of words in the received input strings. For the located one or more documents, execute a keyword extractor component and/or text categorizer to calculate a relevancy score for the one or more words and/or the one or more categories of words in the located one or more documents to generate a results document. Processing then proceeds to block 608 where the results document is represented as a document term vector using one or more words and/or categories of words and one or more relevancy scores. The document term vector is then normalized at block 610. Processing then proceeds to block 612 where the averaged term vector of the normalized document term vectors is calculated. The averaged normalized document term vector is provided as output at block 614.

The methods can be implemented by computer-executable instructions stored on one or more computer-readable media or conveyed by a signal of any suitable type. The methods can be implemented at least in part manually. The steps of the methods can be implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

Moreover, it is to be appreciated that various aspects as described herein can be implemented on portable computing devices (e.g., field medical device), and other aspects can be implemented across distributed computing platforms (e.g., remote medicine, or research applications). Likewise, various aspects as described herein can be implemented as a set of services (e.g., modeling, predicting, analytics, etc.).

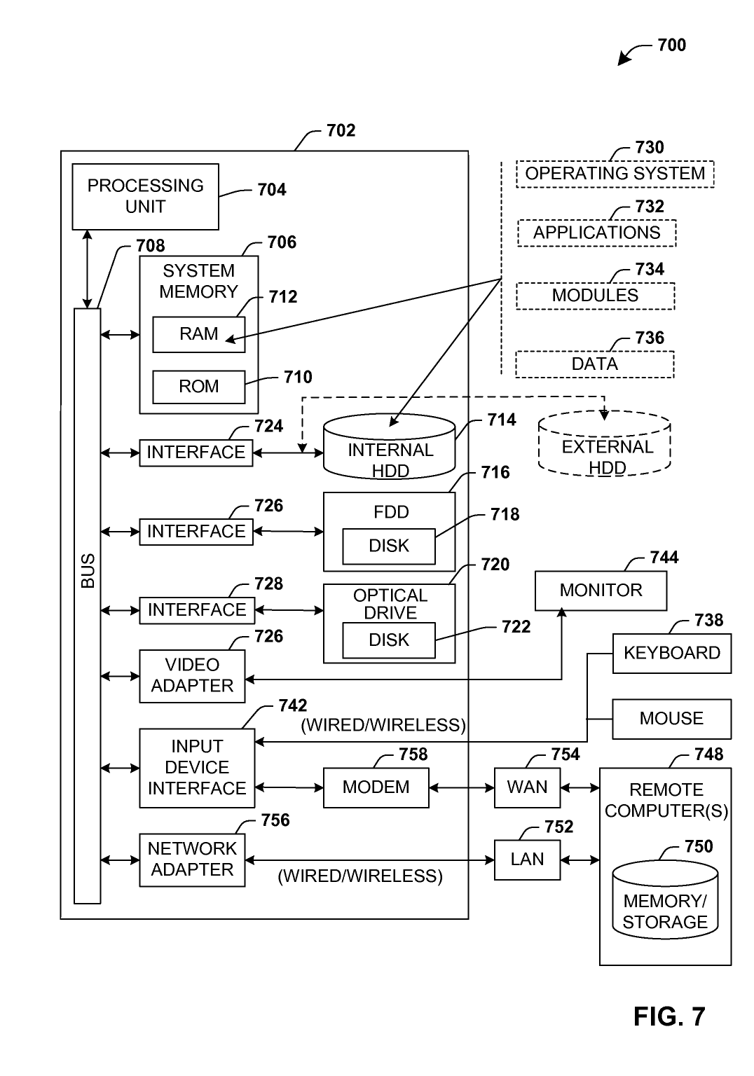

FIG. 7 illustrates a block diagram of a computer operable to execute the disclosed architecture. In order to provide additional context for various aspects of the subject specification, FIG. 7 and the following discussion are intended to provide a brief, general description of a suitable computing environment 700 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single- processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

More particularly, and referring to FIG. 7, an example environment 700 for implementing various aspects as described in the specification includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the specification can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are example and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

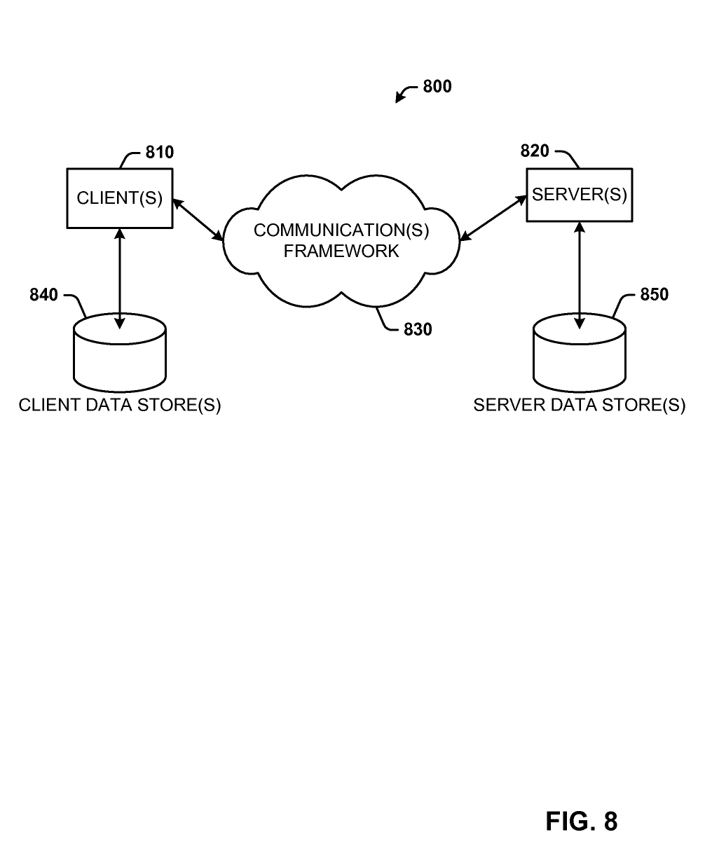

Referring now to FIG. 8, there is illustrated a schematic block diagram of an exemplary computing environment 800 in accordance with the subject invention. The system 800 includes one or more client(s) 810. The client(s) 810 can be hardware and/or software (e.g., threads, processes, computing devices). The client(s) 810 can house cookie(s) and/or associated contextual information by employing the subject invention, for example. The system 800 also includes one or more server(s) 820. The server(s) 820 can also be hardware and/or software (e.g., threads, processes, computing devices). The servers 820 can house threads to perform transformations by employing the subject methods and/or systems for example. One possible communication between a client 810 and a server 820 can be in the form of a data packet adapted to be transmitted between two or more computer processes. The data packet may include a cookie and/or associated contextual information, for example. The system 800 includes a communication framework 830 (e.g., a global communication network such as the Internet) that can be employed to facilitate communications between the client(s) 810 and the server(s) 820.

Communications can be facilitated via a wired (including optical fiber) and/or wireless technology. The client(s) 810 are operatively connected to one or more client data store(s) 840 that can be employed to store information local to the client(s) 810 (e.g., cookie(s) and/or associated contextual information). Similarly, the server(s) 820 are operatively connected to one or more server data store(s) 850 that can be employed to store information local to the servers 820.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for measuring similarities in short segments of text comprising:
a short text engine operative to receive and process short text segment data; and
an instruction set comprising at least one instruction to instruct the short text engine to process received short text segment data according to a selected short text similarity identification paradigm
wherein the selected short text similarity identification paradigm comprises one or more instructions to process received short text segment data comprising one or more words applying one or more web-relevancy similarity measure techniques executing one or more operations comprising locating by a cooperating search engine one or more documents that contain one or more words of the received short text segment data, calculating a relevancy score for the one or more words of the located one or more documents to generate a results document for each of the one or more located documents, representing the results document as a document term vector for each of the located documents using the one or more words of the received short text segment data and the calculated relevancy scores, and normalizing the document term vector.

2. The system as recited in claim 1, further comprising a keyword extractor component operative to calculate the relevancy score for one or more words in the document.

3. The system as recited in claim 2, further comprising a text categorizer component operative to indentify one or more categories of the one or more words and calculate one or more relevancy scores of the one or more categories.

4. The system as recited in claim 1, wherein the short text engine calculates an averaged term vector for the calculated normalized document term vectors for each of the located documents.

5. The system as recited in claim 1, wherein the averaged term vector contains data representative of a similarity measure for the received short text segment data.

6. The system as recited in claim 1, wherein the document term vector calculated using data from a result page generated by the cooperating search engine.

7. The system as recited in claim 1, wherein a similarity score of short text segment data is calculated as the inner product of the calculated one or more document term vectors of the short text segment data.

8. The system as recited in claim 1, wherein the short text engine combines two or more similarity scores according to a parameterized function trained using a machine learning algorithm.

9. A method for identifying one or more similarities in one or more short text segments comprising:
receiving short text segment data as input;
applying one or more web-relevancy similarity measure techniques to the received short text segment data to calculate similarity scores; and
providing the similarity scores as an output.

10. The method as recited in claim 9, further comprising locating documents containing one or more words in the received short test segment data by a cooperating search engine.

11. The method as recited in claim 10, further comprising calculating relevancy scores for the one or more words of the located documents.

12. The method as recited in claim 10, further comprising calculating relevancy scores for one or more categories of one or more words of the located documents.

13. The method as recited in claim 12, further comprising representing the processed one or more documents as the one or more document term vectors using the one or more words and the determined relevancy scores.

14. The method as recited in claim 13, further comprising normalizing the one or more document term vectors to generate one or more normalized document term vectors.

15. The method as recited in claim 14, further comprising calculating the average term vector for the one or more normalized document term vectors to generate the normalized average document term vector.

16. The method as recited in claim 9, further comprising combining similarity scores from one or more sources generating similarity scores for short text segments wherein the output is a real-valued score.

17. The method as recited in claim 16, further comprising combining similarity scores according to a parameterized function.

18. The method as recited in claim 9, further comprising calculating the inner product of the document term vectors of the received short text segments to generate a similarity score.

19. The method as recited in claim 9, further comprising calculating the document term vectors using the results page generated by a cooperating search engine.

20. A computer-readable medium having computer executable instructions to instruct a computing environment to perform a method comprising:
receiving short text segment data as input;
applying one or more web-relevancy similarity measure techniques to the received short text segment data to calculate similarity scores; and providing the similarity scores as an output.
